(19) United States
(12) Patent Application Publication
(10) Pub. No.: US 2012/0294970 A1
(43) Pub. Date: Nov. 22, 2012

(54) AUTOMATIC CLEAN CURL-SHAPING DEVICE FOR PAPERBOARD

(75) Inventor: Kweon-Shik Min, Chungcheongnam-do (KR)

(73) Assignee: DONGNAM PRINTING.CO., LTD, (KR)

(21) Appl. No.: 13/575,735

(22) PCT Filed: Aug. 16, 2010
(86) PCT No.: PCT/KR2010/005383

§ 371 Date: Jul. 27, 2012

(30) Foreign Application Priority Data
Apr. 8, 2010 (KR) 10-2010-0032430

(51) Int. Cl. B28B 5/02

(52) U.S. Cl. 425/337

(57) ABSTRACT

The present invention relates to a curl-shaping device for paperboard, including: a conveying part adapted to convey the paperboard; a compressing part adapted to compress the top surface of the paperboard; a curl-shaping part disposed at the side of the conveying part to form a curled portion along the lateral side of the paperboard; a natural cooling and shaping part formed at the front portion of the curling-shaping part to fix the curled portion again; and a paperboard lateral side guide disposed at the opposite side to the curling-shaping part to push the opposite lateral side to one lateral side of the paperboard where the curled portion is formed.

### BACKGROUND OF THE INVENTION

1. Field of the Invention

The present invention relates to a curl-shaping device for paperboard that is provided with a compressing part disposed on the upper side of a conveying part to allow the forces of compression rollers to be applied evenly to the paperboard, a paperboard lateral side guide disposed along one side surface of the conveying part in such a manner as to allow the lateral end of the paperboard to be brought into close contact with a curl-shaping groove of a curl-shaping part, a heat wire disposed obliquely on the curl-shaping part in parallel to the curl-shaping groove to allow the heat generated therefrom to be transmitted evenly to the lateral end of the paperboard being passed through the curl-shaping groove, and a natural cooling and shaping part extended forwardly from the curl-shaping part to allow a curled portion formed along the lateral end of the paperboard to be fixed again and naturally cooled, thereby achieving the formation of the curled portion to a more perfect shape.

2. Background of the Related Art

Generally, a folding box is made of paperboard whose end portions are curled to prevent the edges thereof from being crushed and further to increase the stiffness of the box. According to conventional curling methods, however, since the folding box has relatively low stiffness, outer paper and inner paper are laminated together, or paper is doubly folded, thereby making it inconvenient to make the box, causing the materials needed for the outer paper and the inner paper to be much consumed, and making it hard to make polygonal boxes except square boxes.

So as to solve the above-mentioned problems, thus, there has been disclosed Korean Patent No. 897806 entitled “curl-shaping device for paperboard”, and referring to the prior art, as shown in FIGS. 1 and 2, the curl-shaping device for paperboard has a conveying part 120 like a conveyor adapted to convey paperboard 110, a compressing part 130 having a plurality of rollers 132 disposed above the conveying part 120 to compress the top surface of the paperboard 110, and a linear curl-shaping part 140 disposed at one side of the conveying part 120 to form a curled portion 112 along the lateral side of the paperboard 110, wherein the curl-shaping part 140 includes a lower mold 142 and an upper mold 141, the lower mold 142 having a paperboard underside support plate 143 adapted to support the underside surface of the lateral end of the paperboard 110 moving from an introducing portion 151 into which the paperboard is introduced to a discharging portion 152 from which the paperboard 110 is ejected, a stepped protrusion 144 formed vertically on the paperboard underside support plate 143 in such a manner as to become inclined inwardly in the moving direction of the paperboard 110, and a curl-shaping groove 145 formed along the stepped protrusion surface in such a manner as to become gradually curved from the introducing portion 151 toward the discharging portion 152, and the upper mold 141 having a paperboard top support plate 148 having a stepped protrusion 149 formed to be brought into close contact with the stepped protrusion 144 of the paperboard underside support plate 143, and the curl-shaping part 140 further includes heating means like a heat wire 150 disposed thereon.

According to the prior art, the plurality of rollers pressurize the top surface of the paperboard to allow the paperboard to be gently moved along the conveying part in the state of being brought into close contact with the conveying part, but in this case, the plurality of rollers are provided individually to make the forces applied to the top surface of the paperboard different from each other, thereby causing the movement of the paperboard to be not gently performed in a given section of the conveyor.

Further, the lateral end of the paperboard should be moved in the close contact with the curl-shaping groove so as to successfully form the curled portion on the paperboard, but according to the conventional practice, there is no part for pushing the opposite lateral end to one lateral end of the paperboard moving along the curl-shaping groove, so that the lateral end of the paperboard where the curled portion is formed is not moved stably in the state of being brought into close contact with the curl-shaping groove, thereby resulting in the deviation from the curl-shaping groove to cause the defect in the formation of the curled portion.

So as to achieve the formation of the curled portion in a perfect manner, furthermore, heat is transmitted evenly to the lateral end of the paperboard where the curled portion is formed, but the heat wire transmitting the heat to the lateral end of the paperboard is disposed in parallel to the stepped protrusion of the lower mold, so that the width between the heat wire and the curl-shaping groove becomes gradually open from the introducing portion toward the discharging portion, thereby failing to transmit the heat evenly to the lateral end of the paperboard.

Additionally, the curled portion passed through the curl-shaping groove is perfectly formed through natural cooling, but according to the prior art, when the curled portion to which the heat is applied is just passed through the curl-shaping groove, the heat of the curled portion is drastically lowered and naturally cooled, so that the curled portion is not kept at the curled state and is often uncurled, thereby causing the defect of the curled portion.

According to the prior art, moreover, the curled portion is formed only on any one of left and right sides of the paperboard, thereby making it hard to form the curled portion on the left and right sides of the paperboard.

### SUMMARY OF THE INVENTION

Accordingly, the present invention has been made in view of the above-mentioned problems occurring in the prior art, and it is an object of the present invention to provide a curl-shaping device for paperboard that has a compressing part disposed with given tension on the upper side of a conveying part to allow the forces of compression rollers to be applied evenly to the paperboard, thereby achieving the movement of the paperboard in a gentle manner.

It is another object of the present invention to provide a curl-shaping device for paperboard that has a paperboard lateral side guide disposed along one side surface of a conveying part to allow the lateral end of the paperboard to be brought into close contact with a curl-shaping groove, thereby achieving the formation of a curled portion on the paperboard to a perfect shape.

It is still another object of the present invention to provide a curl-shaping device for paperboard that has a heat wire disposed obliquely on a curl-shaping part in parallel to a curl-shaping groove to allow the heat generated therefrom to be transmitted evenly to the lateral end of the paperboard being passed through the curl-shaping groove, thereby achieving the formation of the curled portion with ease.

It is yet another object of the present invention to provide a curl-shaping device for paperboard that has a natural cooling and shaping part extended forwardly from a curl-shaping part and having a curl-cooling groove corresponding to a curl-shaping groove of the curl-shaping part to allow a curled portion formed along the lateral end of the paperboard to be fixed again and naturally cooled, thereby achieving the formation of the curled portion to a more perfect shape.

It is still yet another object of the present invention to provide a curl-shaping device for paperboard whose components disposed symmetrically on left and right sides of the paperboard, thereby achieving the formation of the curled portions on the paperboard on both lateral ends of the paperboard at the same time.

To accomplish the above objects, according to a first aspect of the present invention, there is provided a curl-shaping device for paperboard, including: a conveying part adapted to convey the paperboard; a compressing part having a plurality of compression rollers arranged in a row above the conveying part to pressurize the top surface of the paperboard, supporting frames adapted to support the ends of the shafts of the compression rollers to allow the compression rollers to be rotated, a connecting frame adapted to connect the supporting frames one another to allow the compression rollers to apply the top surface of the paperboard with the forces applied equally therefrom, and an upper frame extended upwardly from one end of the top surface of the connection frame in such a manner as to be bent in the lateral direction; a curl-shaping part disposed at one side of the conveying part to form a curled portion along the lateral side of the paperboard, the curl-shaping part being composed of a lower mold and an upper mold, the lower mold having a paperboard underside support plate adapted to support the underside surface of the lateral end of the paperboard moving from an introducing portion into which the paperboard is introduced to a discharging portion from which the paperboard is discharged, a first stepped protrusion formed vertically on the paperboard underside support plate in such a manner as to become inclined inwardly in the moving direction of the paperboard, and a curl-shaping groove formed along the first stepped protrusion surface in such a manner as to become gradually curved from the introducing portion toward the discharging portion, and the upper mold having a paperboard top support plate disposed on top of the lower mold and having a second stepped protrusion formed to be brought into close contact with the first stepped protrusion of the paperboard underside support plate; and a natural cooling and shaping part adapted to naturally cool the curled portion of the paperboard, while maintaining the curled portion passed through the curl-shaping groove in the shape, the natural cooling and shaping part having a curl-cooling groove extended from the curl-shaping groove formed at the discharging portion and having a shape corresponding to the curled portion to allow the curled portion to be passed therethrough.

According to the present invention, preferably, the curl-cooling groove of the natural cooling and shaping part is extended linearly from the curl-shaping groove at the discharging portion in such a manner as to correspond to the curl-shaping groove at the discharging portion.

According to the present invention, preferably, the curl-shaping device for paperboard further includes a paperboard lateral side guide disposed on the opposite side to one side of the paperboard where the curled portion is formed, the paperboard lateral side guide including: a plurality of rollers arranged in a row in such a manner as to be brought into close contact with the opposite side to one side of the paperboard where the curled portion is formed; a roller connection frame connected to the ends of the shafts of the rollers in such a manner as to connect the rollers one another and having an operating space formed at the inside thereof; a pressurizing plate disposed at the rear side of the inside of the operating space of the roller connection frame; pressurizing springs disposed spaced equally apart from each other between the roller connection frame and the pressurizing plate; and an operating cylinder having a front end rod connected to the rear side of the pressurizing plate.

According to the present invention, preferably, the paperboard lateral side guide further includes a bent protrusion formed bent inwardly at both side edges of the rear end of the roller connection frame to prevent the pressurizing plate from being separated from the roller connection frame.

According to the present invention, preferably, the lower mold has a heat wire disposed thereon in parallel to the curl-shaping groove.

To accomplish the above objects, according to a second aspect of the present invention, there is provided a curl-shaping device for paperboard, including: curl-shaping parts disposed correspondingly at both lateral sides of a conveying part to form curled portions along both lateral sides of the paperboard, each curl-shaping part being composed of a lower mold and an upper mold, the lower mold having a paperboard underside support plate adapted to support the underside surface of the lateral end of the paperboard moving from an introducing portion into which the paperboard is introduced to a discharging portion from which the paperboard is discharged, a first stepped protrusion formed vertically on the paperboard underside support plate in such a manner as to become inclined inwardly in the moving direction of the paperboard, and a curl-shaping groove formed along the first stepped protrusion surface in such a manner as to become gradually curved from the introducing portion toward the discharging portion, and the upper mold having a paperboard top support plate disposed on top of the lower mold and having a second stepped protrusion formed to be brought into close contact with the first stepped protrusion of the paperboard underside support plate; natural cooling and shaping parts adapted to naturally cool the curled portions of the paperboard, while maintaining the curled portions passed through the curl-shaping grooves in the shape, each natural cooling and shaping part having a curl-cooling groove extended from the curl-shaping groove formed at the discharging portion and having a shape corresponding to the curled portion to allow the curled portion to be passed therethrough; lateral frames connected correspondingly to the external sides of the curl-shaping parts; and push cylinders whose rods connected to the center portions of the external sides of the lateral frames.

According to the present invention, preferably, the curl-shaping device for paperboard further includes a compressing part having a plurality of compression rollers arranged in a row above the conveying part conveying the paperboard to pressurize the top surface of the paperboard, supporting frames adapted to support the ends of shafts of the compression rollers to allow the compression rollers to be rotated, a connecting frame adapted to connect the supporting frames one another and to allow the compression rollers to apply the top surface of the paperboard with the forces applied equally therefrom, and an upper frame extended upwardly from one end of the top surface of the connection frame in such a manner as to be bent in the lateral direction, the compressing part being connected to any one of the lateral frames disposed symmetrically on left and right sides thereof.

According to the present invention, preferably, the curl-shaping device for paperboard further includes a compressing part having a plurality of compression rollers arranged in a row above the conveying part conveying the paperboard to pressurize the top surface of the paperboard, supporting frames adapted to support the ends of shafts of the compression rollers to allow the compression rollers to be rotated, a connecting frame adapted to connect the supporting frames one another and to allow the compression rollers to apply the top surface of the paperboard with the forces applied equally therefrom, and an upper frame extended upwardly from one end of the top surface of the connection frame in such a manner as to be bent in the lateral direction, the compressing part being connected to both of the lateral frames disposed symmetrically on left and right sides thereof.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a conventional curl-shaping device for paperboard;

FIG. 2 is a separate perspective view showing a curl-shaping part in the conventional curl-shaping device for paperboard;

FIG. 3 is a perspective view showing a curl-shaping device for paperboard according to a first embodiment of the present invention;

FIG. 4 is a plane view showing the curl-shaping device for paperboard according to the first embodiment of the present invention;

FIG. 5 is a side view showing a paperboard lateral side guide in the curl-shaping device for paperboard according to the first embodiment of the present invention;

FIG. 6 is an enlarged separate perspective view showing the curl-shaping part in the curl-shaping device for paperboard according to the first embodiment of the present invention;

FIG. 7 is a perspective view showing a curl-shaping device for paperboard according to a second embodiment of the present invention; and

FIG. 8 is a plane view showing the curl-shaping device for paperboard according to the second embodiment of the present invention.

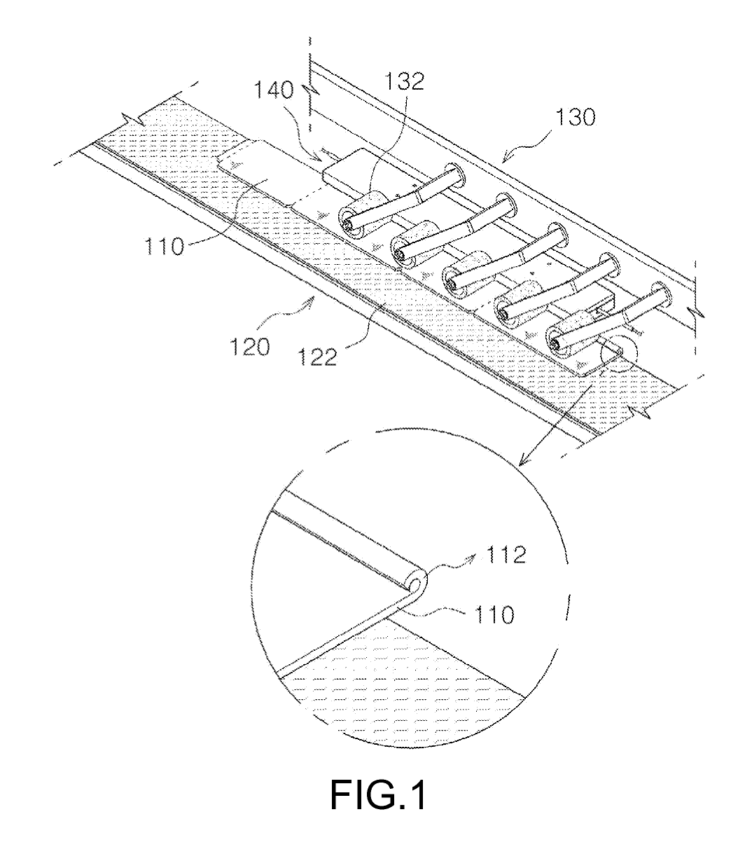

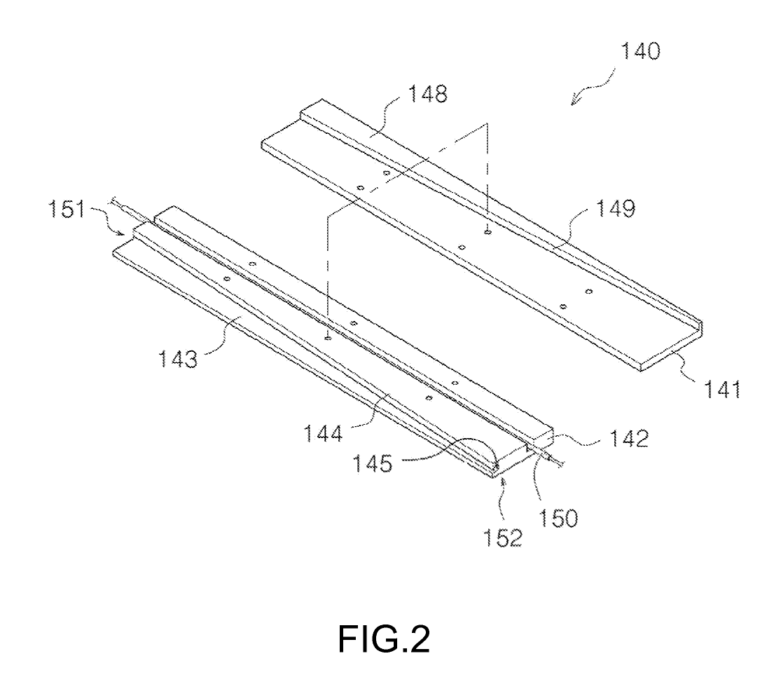

### DETAILED DESCRIPTION OF THE PREFERRED EMBODIMENT

Hereinafter, an explanation on a curl-shaping device for paperboard according to preferred embodiments of the present invention will be in detail given with reference to the attached drawings.

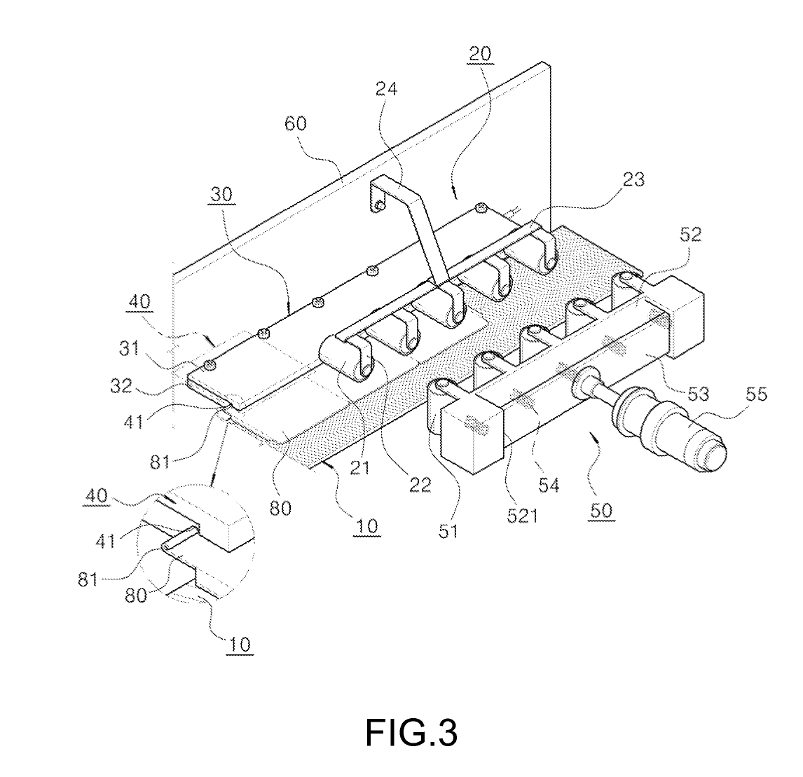

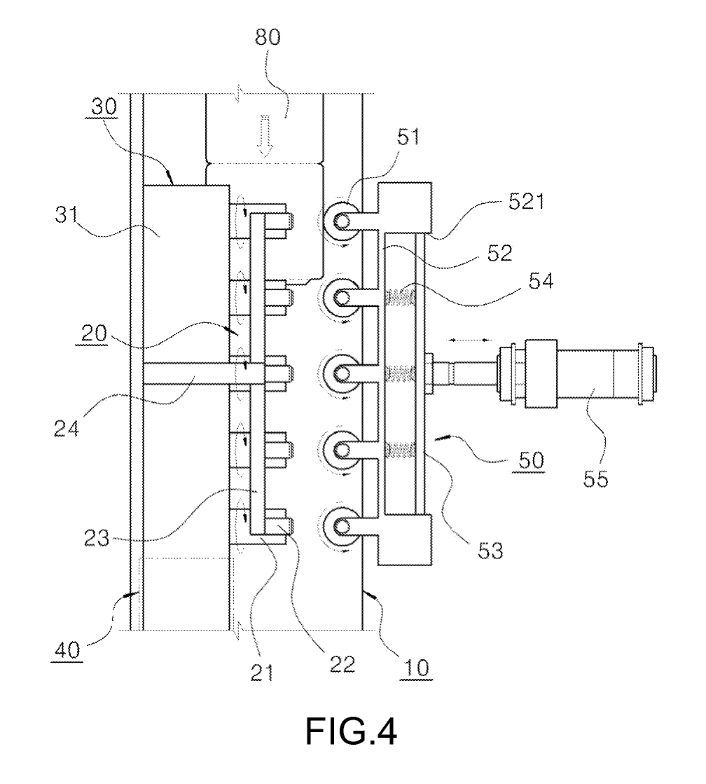

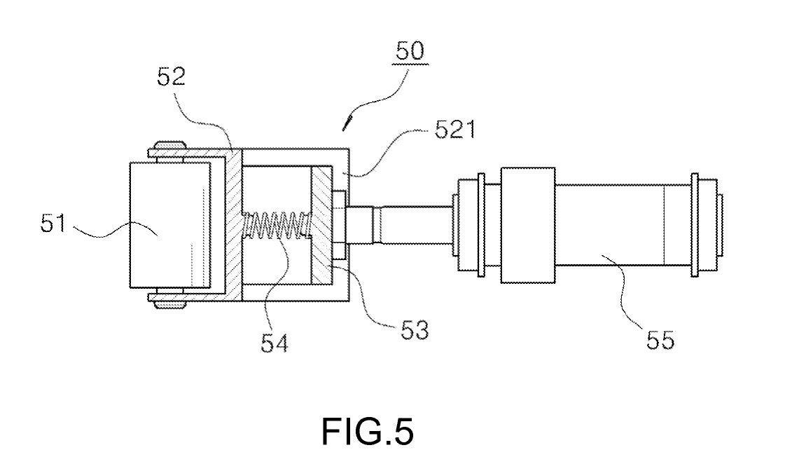

FIG. 3 is a perspective view showing a curl-shaping device for paperboard according to a first embodiment of the present invention, and FIG. 4 is a plane view showing the curl-shaping device for paperboard according to the first embodiment of the present invention. As shown in FIGS. 3 and 4, a curl-shaping device for paperboard according to the first embodiment of the present invention includes: a conveying part 10 like a conveyor adapted to convey the paperboard 80; a compressing part 20 adapted to compress the top surface of the paperboard 80 so that the paperboard 80 can be gently moved along the conveying part 10; a curl-shaping part 30 disposed at one side of the conveying part 10 to form a curled portion 81 along the lateral side of the paperboard 80; and a natural cooling and shaping part 40 formed at the front portion of the curling-shaping part 30 to fix the curled portion 81 again at the time when the curled portion 81 of the paperboard 80 is passed through the curl-shaping part 30 and to prevent the curled portion 81 from being changed in shape; and a paperboard lateral side guide 50 disposed at the opposite side to the curling-shaping part 30 so as to push the opposite lateral side to one lateral side of the paperboard 80 where the curled portion 81 is formed so that one lateral side of the paperboard 80 where the curled portion 81 is formed is brought into close contact with the curl-shaping part 30.

The conveying part 10 is composed of a conveyor having a width corresponding to the paperboard 80 so as to convey the paperboard 80 in a given direction, and the paperboard 80 is formed of relatively thick and coarse paper having a thickness in a range between 0.5 mm and 3 mm, which is usually used for packaging boxes. Especially, Manila paper, which has colors and soft surface and are used mainly for high-quality of color boxes, may be used as the paperboard 80, and further, corrugated paper or various paper for packaging boxes may be used as the paperboard 80.

The compressing part 20 is adapted to allow the paperboard 80 moving along the conveying part 10 to be brought into close contact with the conveying part 10 and to be easily conveyed therealong, and the compressing part 20 has a plurality of compression rollers 21 disposed in close contact with the paperboard 80 moving on the conveying part 10, a supporting frames 22 adapted to support the ends of the shafts of the compression rollers 21, a connecting frame 23 adapted to connect the supporting frames 22 one another and to allow the forces of the compression rollers 21 to be applied evenly to the paperboard 80, and an upper frame 24 extended upwardly from the center of the connection frame 23.

The compression rollers 21 are rotatable and arranged in a row in such a manner as to be brought into close contact with the paperboard 80 moving on the conveying part 10. Each compression roller 21 is adapted to compress the paperboard 80 with a given force, thereby gently conveying the paperboard 80.

So as to allow the compression rollers 21 to be rotated, the support frames 22 are desirably bent in a shape of ‘ [symbol] ’ with a given tension, while being connected to one side ends of the shafts of the compression rollers 21.

The connection frame 23 is connected to the support frames 22 of the compression rollers 21 and is adapted to connect the support frames 22 one another, while being moved along the compression rollers 21, so that when the paperboard 80 is compressed by means of the compression rollers 21, the forces of the compression rollers 21 are applied equally to the paperboard 80.

The upper frame 24 is extended upwardly from the center of the connection frame 23 in such a manner as to be bent in a shape of ‘ [symbol] ’ with a given tension and to be supported at the end thereof against a lateral frame 60.

As shown in FIGS. 3 to 5, the paperboard lateral side guide 50 is adapted to allow the lateral end of the paperboard 80 disposed in close contact with a curl-shaping groove 325 to come into very close contact with the curl-shaping groove 325, thereby improving the degree of completion of the curled portion 81. The paperboard lateral side guide 50 includes a plurality of rollers 51 adapted to be brought into close contact with the lateral end of the paperboard 80 not contacted with the curl-shaping groove 325 in the left and right lateral ends of the paperboard 80, a roller connection frame 52 adapted to support the ends of the shafts of the rollers 51 and to connect the rollers 51 one another, a pressurizing plate 53 disposed at the rear side of the inner portion of the roller connection frame 52, and pressurizing springs 54 disposed spaced equally apart from each other between the roller connection frame 52 and the pressurizing plate 53.

The rollers 51 are spaced equally apart from each other in a row in such a manner as to be brought into close contact with the other lateral end of the paperboard 80, thereby allowing one lateral end of the paperboard 80 disposed in close contact with the curl-shaping groove 325 to be pushed toward the curl-shaping groove 325.

The roller connection frame 52 is connected to the ends of the shafts of the rollers 51, thereby connecting the rollers 51 one another, and has an operating space where the pressurizing plate 53 is operated formed at the inside thereof and a bent protrusion 521 formed bent inwardly at both side edges of the rear end thereof to prevent the pressurizing plate 53 from being separated from the roller connection frame 52.

The pressurizing plate 53 is disposed at the rear side of the operating space inside the roller connection frame 52 and is moved forwardly and backwardly in accordance with the expansion and contraction of an operating cylinder 55 connected to the rear side thereof. The pressurizing springs 54, which are disposed between the roller connection frame 52 and the pressurizing plate 53, are adapted to allow the rollers 51 to come into close contact with the lateral end of the paperboard 80 by means of the expansion and contraction thereof.

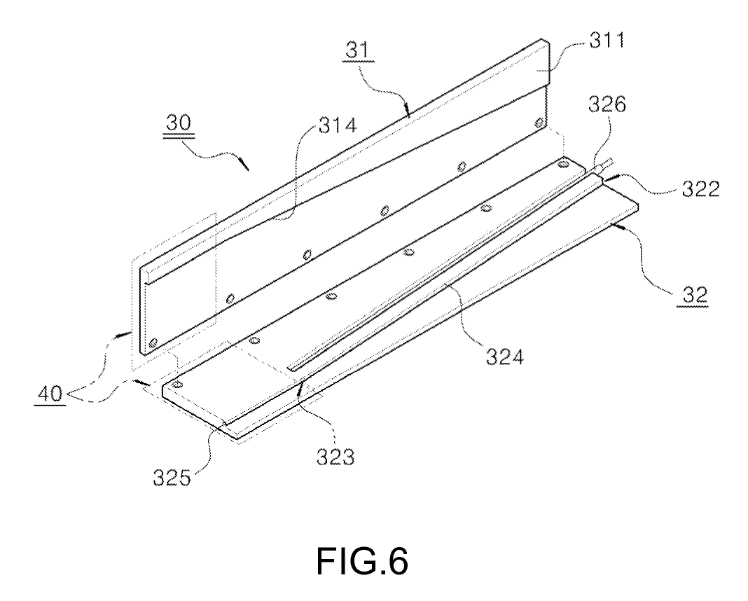

As shown in FIG. 6, the curl-shaping part 30 includes a lower mold 32 disposed at one side of the conveying part 10 in such a manner as to be brought into close contact with the lateral end and underside of the paperboard 80 and to form the curled portion 81 along the lateral end of the paperboard 80, and an upper mold 31 disposed correspondingly on the top of the lower mold 32 in such a manner as to support the top portion of the lateral end of the paperboard 80 moving along the conveying part 10, to prevent the movement of the lateral end of the paperboard 80 and to help the formation of the curled portion 81 together with the lower mold 32.

The lower mold 32 includes a paperboard underside support plate 321 adapted to support the underside surface of the lateral end of the paperboard 80 moving from an introducing portion 322 into which the paperboard 80 is introduced toward a discharging portion 323 from which the paperboard 80 is discharged, and a stepped protrusion 324 formed vertically on the paperboard underside support plate 321 in such a manner as to become inclinedly narrow in width in the moving direction of the paperboard 80, that is, toward the discharging portion 323 from the introducing portion 322, and to be brought into close contact with the end portion of the paperboard 80.

The curl-shaping groove 325 is formed along the portion where the paperboard underside support plate 321 and the stepped protrusion 324 are contacted with each other, and it is somewhat curved toward the inside of the stepped protrusion 324 at the portion where the introducing portion 322 into which the paperboard 80 is introduced starts and is more curved toward the inside of the stepped protrusion 324 along the portion where the discharging portion 323 is formed, so that the curl-shaping groove 325 has a generally semi-circular shape in the discharging portion 323.

The paperboard 80 has the curled portion 81 formed along the lateral end thereof after it has been passed through the curl-shaping groove 325 formed along the stepped protrusion 324, and at this time, the stepped protrusion 324 inclined inwardly along the moving direction of the paperboard 80 from the introducing portion 322 toward the discharging portion 323 desirably has an inward angle between 1.7° and 2.5° in accordance with the thickness of the paperboard 80, the length of the lateral end of the paperboard 80 and the molding conditions.

If the inward angle is smaller than 1.7°, the whole length of the curl-shaping part 30 should be extended to form the curled portion 81 in the same manner, so that the manufacturing costs for the upper and lower molds 31 and 32 are raised and the time for forming the curled portion 81 is increased. Contrarily, if the inward angle is larger than 2.5°, the whole length of the curl-shaping part 30 should be reduced to form the curled portion 81 in the same manner, but the curling is carried out urgently to cause the curled portion 81 to be easily deformed.

Further, the lower mold 32 has heating means adapted to help the curled portion 81 to be well formed on the paperboard 80, and the heating means is composed of a heat wire 326 that is inserted into an insertion groove formed spaced apart from the obliquely formed curl-shaping groove 325 along which the lateral end of the paperboard 80 is moved to form the curled portion 81, thereby transmitting the heat evenly to the curl-shaping groove 325.

On the other hand, if heat is not applied to the lateral end of the paperboard 80 when the curled portion 81 is formed, the tissues of the paperboard 80 may be damaged in accordance with the materials of the paperboard 80 to cause the curled state to be undesirably crushed, thereby making it hard to well maintain the curled state after the curling.

Accordingly, the heat wire 326 is disposed obliquely on the lower mold 32 in parallel to the stepped protrusion 324 and the curl-shaping groove 325, thereby transmitting the heat evenly to the lateral end of the paperboard 80 moving along the curl-shaping groove 325, so that the tissues of the paperboard 80 become soft along the lateral end contacted with the curl-shaping groove 325 by the heat transmitted to the heat wire 326. Further, in the state where the tissues of the lateral end of the paperboard 80 are soft, the lateral end of the paperboard 80 is passed through the curl-shaping groove 325, thereby forming the curled portion 81 to a perfect shape.

At this time, the heating temperature of the heat wire 326 is within a range between 120° C. and 150° C. If the heating temperature is less than 120° C., it is difficult to make the tissues of the paperboard 80 soft, thereby failing to form the curled portion 81 to a perfect shape. Contrarily, if the heating temperature is more than 150° C., electricity consumption is increased to maintain the temperature and the film attached to the paperboard 80 may be burnt.

The upper mold 31 is disposed on top of the lower mold and has a paperboard top support plate 311 disposed to correspond to the moving space of the lateral end of the paperboard 80 formed by the paperboard underside support plate 321 and the stepped protrusion 324 of the lower mold 32, and a stepped protrusion 314 formed along the top portion of the internal surface thereof.

If the upper mold 31 is coupled to the top of the lower mold 32, the stepped protrusion 324 of the upper mold 31 comes in contact with the stepped protrusion 324 of the lower mold 32, and the paperboard top support plate 311 of the upper mold 31 comes in contact with the paperboard underside support plate 321 of the lower mold 32, while having a space through which the paperboard 80 is passed therebetween.

If the paperboard 80 is passed through the space between the paperboard top support plate 311 and the paperboard underside support plate 321, the lateral end of the paperboard 80 is not moved at all at the time of the formation of the curled portion 81 by means of the curl-shaping groove 325 of the lower mold 32.

On the other hand, as the paperboard 80 is moved forwardly at the time of the curling, it is curled gradually toward the top surface thereof, and accordingly, a guide bar may be disposed along the inside of the curl-shaping groove 325 to gently guide the curled paperboard along the curl-shaping groove 325, without having any distortion of the curled portion 81, thereby performing the formation of the curled portion 81 to a more perfect state.

In this case, the guide bar should be positioned within the curl-shaping groove 325 of the lower mold 32, but if it is disposed on the lower mold 32, it interrupts the movement of the paperboard 80. Accordingly, the guide bar is desirably disposed on the position of the upper mold 31 corresponding to the curl-shaping groove 325.

As shown in FIG. 6, the natural cooling and shaping part 40 is extended forwardly from the curl-shaping part 30 to fix the curled portion 81 again at the time when the curled portion 81 of the paperboard 80 is passed through the curl-shaping part 30, thereby finishing the formation of the curled portion 81 in a more perfect state. The natural cooling and shaping part 40 has a curl-cooling groove 41 extended from the curl-shaping groove 325 formed at the discharging portion 323 where the formation of the curled portion 81 is finished, in the same shape as the curl-shaping groove 325.

At this time, after the curled portion 81 of the paperboard 80 has been passed through the end of the curl-shaping groove 325 positioned at the discharging portion 323, it is moved linearly, so that the curl-cooling groove 41 is desirably maintained in a linear state to the end of the curl-shaping groove 325 along the moving path of the curled portion 81.

Accordingly, after the curled portion 81 has been passed through the end of the curl-shaping groove 325, it is passed through the curl-cooling groove 41 and is fixed again in shape, thereby making the curled portion 81 well formed and at the same time naturally cooled, so that the curled portion 81 is not changed in shape.

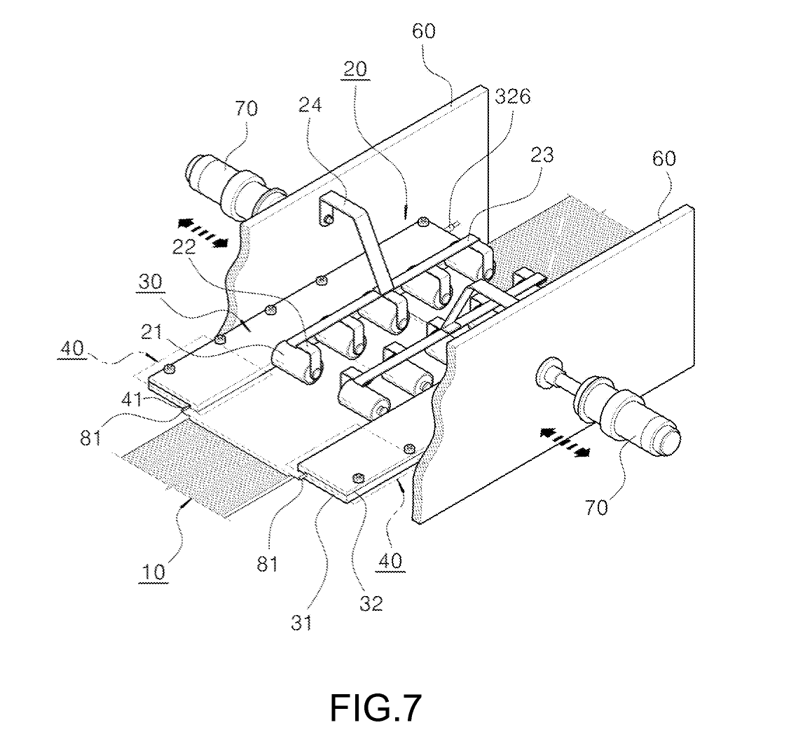

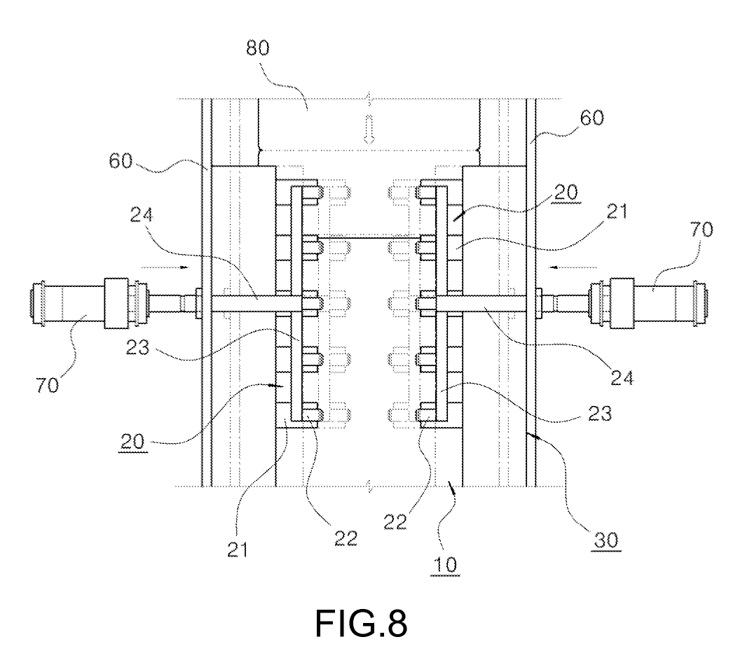

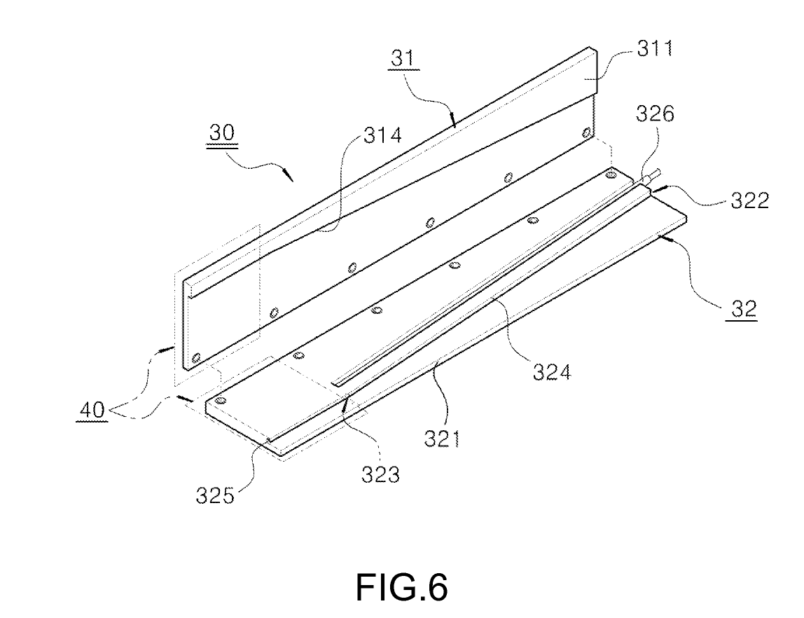

On the other hand, FIGS. 7 and 8 show a curl-shaping device for paperboard according to a second embodiment of the present invention, wherein a curled portion 81 can be formed at the same time on the left and right lateral ends of the paperboard 80.

According to the second embodiment of the present invention, the curl-shaping device for paperboard includes: compressing parts 20 disposed symmetrically on left and right sides around a conveying part 10 in such a manner as to compress the top surface of the paperboard 80 moving along the conveying part 10; curl-shaping parts 30 disposed on the left and right sides of the conveying part 10 to form curled portions 81 along the lateral ends of the paperboard 80; natural cooling and shaping parts 40 extended forwardly from the curl-shaping parts 30; lateral frames 60 connected to the compressing parts 20 and the external lateral sides of the curl-shaping parts 30; and push cylinders 70 whose rods connected to the external lateral ends of the lateral frames 60.

In the second embodiment of the present invention, the conveying part 10, the compressing parts 20, the curl-shaping parts 30 and the natural cooling and shaping parts 40 have the same configurations as those in the first embodiment of the present invention, and therefore, an explanation of them will be avoided.

Like this, if the components of the curl-shaping device for paperboard are disposed symmetrically on left and right sides around the conveying part 10, in normal cases, the curled portion 81 is formed only on one lateral end of the paperboard 80 by using any one side components of the curl-shaping device, and in particular cases, the left and right components of the curl-shaping device are all used to form the curled portions 81 on the left and right lateral ends of the paperboard 80.

That is, if the front end rods of the push cylinders 70 disposed symmetrically in accordance with the width of the paperboard 80 introduced into the conveying part 10 are extended, the both lateral frames 60 are moved toward the sides of conveying part 10. At the same time, the compressing parts 20 connected to the lateral frames 60 are disposed on the top surface of the paperboard 80 to compress the paperboard 80 thereagainst, and the both side curl-shaping parts 30 are disposed at positions where the curled portions 81 are formed at both lateral ends of the paperboard 80.

On the other hand, the compressing part 20 may be disposed only on any one side of the conveying part 10, but if necessary, the compressing parts 20 are disposed symmetrically on the left and right sides of the conveying part 10.

Hereinafter, an operation of the curl-shaping device for paperboard according to the first embodiment of the present invention will be discussed with reference to FIGS. 3 to 6.

So as to form the curled portion 81 along the lateral end of the paperboard 80, as shown in FIGS. 3 to 6, the lateral end of the paperboard 80 is fed horizontally in such a manner as to be brought into contact with the curl-shaping groove 325 at the introducing portion 322 side of the curl-shaping part 30, and at the same time, the front end of the rod of the operating cylinder 55 of the paperboard lateral side guide 50 is extended to allow the lateral end of the paperboard 80 where the curled portion 81 is formed to come into very close contact with the curling groove 325.

That is, if the front end of the rod of the operating cylinder 55 is extended, the pressurizing plate 53 connected to the rod starts to pressurize the pressurizing springs 54, and the pressurizing springs 54 push the roller connection frame 52 to allow the rollers 51 to be brought into close contact with the lateral end of the paperboard 80 where the curled portion 81 is formed, so that the lateral end of the paperboard 80 where the curled portion 81 is formed can be pushed toward the curl-shaping groove 325.

Accordingly, the lateral end of the paperboard 80 where the curled portion 81 is formed is moved from the introducing portion 322 to the discharging portion 323 along the curl-shaping groove 325, while being in close contact with the curl-shaping groove 325, thereby forming the curled portion 81 to a perfect shape, without any deformation.

While the lateral end of the paperboard 80 is being moved in the state of being contacted with the curl-shaping groove 325, on the other hand, the compression rollers 21 of the compressing part 20 press the top surface of the paperboard 80 to allow the paperboard 80 to be gently moved in the state of being brought into close contact with the conveying part 10.

Since the compression rollers 21 are connected with one another by means of the connection frame 23, each compression roller 21 presses the paperboard 80 with a given force, and since the support frames 22 and the upper frame 24 are bent to have given tension, the paperboard 80 is brought into very close contact with the conveying part 10.

While the lateral end of the paperboard 80 is being moved in the state of being contacted with the curl-shaping groove 325, further, heat is transmitted from the heat wire 326 to the lateral end of the paperboard 80 to allow the tissues of the paperboard 80 to be soft to help the formation of the curled portion 81. As shown in FIG. 6, the heat wire 326 is disposed obliquely in parallel to the curl-shaping groove 325 to allow the heat generated therefrom to be transmitted evenly to the whole lateral end of the paperboard 80 being passed through the curl-shaping groove 325, thereby helping the formation of the curled portion 81 in a more perfect manner.

After the curling, the curled portion 81 of the paperboard 80 is passed through the curl-shaping groove 325 at the discharging portion 323 and is then passed through the curl-cooling groove 41 of the natural cooling and shaping part 40 extended linearly from the curl-shaping groove 325 at the discharging portion 323. At this time, the curl-cooling groove 41 serves to fix the shape of the formed curled portion 81 again and to naturally cool the curled portion 81, thereby helping the formation of the curled portion 81 to a more perfect shape.

Next, an operation of the curl-shaping device for paperboard according to the second embodiment of the present invention will be discussed with reference to FIGS. 7 and 8.

The components of the curl-shaping device for paperboard are disposed symmetrically on left and right sides of the conveying part 10, so that the curled portions 81 are formed at the same time on the left and right lateral ends of the paperboard 80.

Hereinafter, since the components of the curl-shaping device for paperboard are disposed symmetrically on left and right sides of the conveying part 10, an operation of the curl-shaping device will be explained with reference to one side of the conveying part 10.

That is, if the rod of the push cylinder 70 is extended, the lateral frame 60 connected to the rod is moved toward the lateral end of the paperboard 80, and the curl-shaping groove 325 of the curl-shaping part 30 connected to the lateral frame 60 is disposed at the lateral end of the paperboard 80 to form the curled portion 81 on the paperboard 80.

In this state, if the lateral end of the paperboard 80 is moved along the curl-shaping part 30, the curled portion 81 is formed on the lateral end of the paperboard 80.

Of course, the curled portions 81 may be formed at the same time on both lateral ends of the paperboard 80 through the components disposed symmetrically on left and right sides of the conveying part 10, and as mentioned above, the curled portion 81 may be formed on one lateral end of the paperboard 80 through the components disposed on one side of the conveying part 10.

Like this, if the components of the curl-shaping device for paperboard are disposed symmetrically on left and right sides of the conveying part 10, the curled portion 81 is formed only on one lateral end of the paperboard 80 as well as on both lateral ends thereof, so that the curl-shaping device can be used for multiple purposes. Further, since the width between the curl-shaping parts 30 is freely adjusted by the operations of the push cylinders 70 disposed symmetrically on both sides of the conveying part 10, the curled portions 81 can be easily formed at the same time on both lateral ends of the paperboard 80 irrespective of the widths of the paperboard 80.

As set forth in the foregoing, according to the first and second embodiments of the present invention, the curl-shaping device for paperboard includes the compressing part disposed with given tension on the upper side of the conveying part to allow the forces of the compression rollers to be applied evenly to the paperboard, thereby achieving the movement of the paperboard in a gentle manner, and includes the paperboard lateral side guide adapted to allow the lateral end of the paperboard to be brought into close contact with the curl-shaping groove, thereby achieving the formation of the curled portion to a perfect shape.

Additionally, the heat wire is disposed obliquely on the curl-shaping part in parallel to the curl-shaping groove to allow the heat generated therefrom to be transmitted evenly to the lateral end of the paperboard being passed through the curl-shaping groove, and after the curled portion has been passed through the curl-shaping groove, it is passed through the curl-cooling groove and is fixed again and naturally cooled, thereby achieving the formation of the curled portion to a more perfect shape.

Furthermore, the components of the curl-shaping device for paperboard are disposed symmetrically on left and right sides of the conveying part, so that the curled portions are formed at the same time on both lateral ends of the paperboard.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A curl-shaping device for paperboard, comprising:
a conveying part adapted to convey the paperboard;
a compressing part having a plurality of compression rollers arranged in a row above the conveying part to pressurize the top surface of the paperboard, supporting frames adapted to support the ends of the shafts of the compression rollers to allow the compression rollers to be rotated, a connecting frame adapted to connect the supporting frames one another to allow the compression rollers to apply the top surface of the paperboard with the forces applied equally therefrom, and an upper frame extended upwardly from one end of the top surface of the connection frame in such a manner as to be bent in the lateral direction;
a curl-shaping part disposed at one side of the conveying part to form a curled portion along the lateral side of the paperboard, the curl-shaping part being composed of a lower mold and an upper mold, the lower mold having a paperboard underside support plate adapted to support the underside surface of the lateral end of the paperboard moving from an introducing portion into which the paperboard is introduced to a discharging portion from which the paperboard is discharged, a first stepped protrusion formed vertically on the paperboard underside support plate in such a manner as to become inclined inwardly in the moving direction of the paperboard, and a curl-shaping groove formed along the first stepped protrusion surface in such a manner as to become gradually curved from the introducing portion toward the discharging portion, and the upper mold having a paperboard top support plate disposed on top of the lower mold and having a second stepped protrusion formed to be brought into close contact with the first stepped protrusion of the paperboard underside support plate; and
a natural cooling and shaping part adapted to naturally cool the curled portion of the paperboard, while maintaining the curled portion passed through the curl-shaping groove in the shape, the natural cooling and shaping part having a curl-cooling groove extended from the curl-shaping groove formed at the discharging portion and having a shape corresponding to the curled portion to allow the curled portion to be passed therethrough.

2. The curl-shaping device for paperboard according to claim 1, wherein the curl-cooling groove of the natural cooling and shaping part is extended linearly from the curl-shaping groove at the discharging portion in such a manner as to correspond to the curl-shaping groove at the discharging portion.

3. The curl-shaping device for paperboard according to claim 1, further comprising a paperboard lateral side guide disposed on the opposite side to one side of the paperboard where the curled portion is formed, the paperboard lateral side guide comprising:
a plurality of rollers arranged in a row in such a manner as to be brought into close contact with the opposite side to one side of the paperboard where the curled portion is formed;
a roller connection frame connected to the ends of the shafts of the rollers in such a manner as to connect the rollers one another and having an operating space formed at the inside thereof;
a pressurizing plate disposed at the rear side of the inside of the operating space of the roller connection frame;
pressurizing springs disposed spaced equally apart from each other between the roller connection frame and the pressurizing plate; and
an operating cylinder having a front end rod connected to the rear side of the pressurizing plate.

4. The curl-shaping device for paperboard according to claim 3, wherein the paperboard lateral side guide further comprises a bent protrusion formed bent inwardly at both side edges of the rear end of the roller connection frame to prevent the pressurizing plate from being separated from the roller connection frame.

5. The curl-shaping device for paperboard according to claim 1, wherein the lower mold has a heat wire disposed thereon in parallel to the curl-shaping groove.

6. A curl-shaping device for paperboard, comprising:
curl-shaping parts disposed correspondingly at both lateral sides of a conveying part to form curled portions along both lateral sides of the paperboard, each curl-shaping part being composed of a lower mold and an upper mold, the lower mold having a paperboard underside support plate adapted to support the underside surface of the lateral end of the paperboard moving from an introducing portion into which the paperboard is introduced to a discharging portion from which the paperboard is discharged, a first stepped protrusion formed vertically on the paperboard underside support plate in such a manner as to become inclined inwardly in the moving direction of the paperboard, and a curl-shaping groove formed along the first stepped protrusion surface in such a manner as to become gradually curved from the introducing portion toward the discharging portion, and the upper mold having a paperboard top support plate disposed on top of the lower mold and having a second stepped protrusion formed to be brought into close contact with the first stepped protrusion of the paperboard underside support plate;
natural cooling and shaping parts adapted to naturally cool the curled portions of the paperboard, while maintaining the curled portions passed through the curl-shaping grooves in the shape, each natural cooling and shaping part having a curl-cooling groove extended from the curl-shaping groove formed at the discharging portion and having a shape corresponding to the curled portion to allow the curled portion to be passed therethrough;
lateral frames connected correspondingly to the external sides of the curl-shaping parts; and
push cylinders whose rods connected to the center portions of the external sides of the lateral frames.

7. The curl-shaping device for paperboard according to claim 6, further comprising a compressing part having a plurality of compression rollers arranged in a row above the conveying part conveying the paperboard to pressurize the top surface of the paperboard, supporting frames adapted to support the ends of the shafts of the compression rollers to allow the compression rollers to be rotated, a connecting frame adapted to connect the supporting frames one another to allow the compression rollers to apply the top surface of the paperboard with the forces applied equally therefrom, and an upper frame extended upwardly from one end of the top surface of the connection frame in such a manner as to be bent in the lateral direction, the compressing part being connected to any one of the lateral frames disposed symmetrically on left and right sides thereof.

8. The curl-shaping device for paperboard according to claim 6, further comprising a compressing part having a plurality of compression rollers arranged in a row above the conveying part conveying the paperboard to pressurize the top surface of the paperboard, supporting frames adapted to support the ends of the shafts of the compression rollers to allow the compression rollers to be rotated, a connecting frame adapted to connect the supporting frames one another to allow the compression rollers to apply the top surface of the paperboard with the forces applied equally therefrom, and an upper frame extended upwardly from one end of the top surface of the connection frame in such a manner as to be bent in the lateral direction, the compressing part being connected to both of the lateral frames disposed symmetrically on left and right sides thereof.
